(19) United States
(12) Patent Application Publication
(10) Pub. No.: US 2025/0282629 A1
(43) Pub. Date: Sep. 11, 2025

(54) PROCESS FOR OPERATING AN AMMONIA SYNTHESIS WITH VARYING PLANT UTILIZATION

(71) Applicants: thyssenkrupp Uhde GmbH, Dortmund (DE); thyssenkrupp AG, Essen (DE)

(72) Inventor: Evgeni GORVAL, Dortmund (DE)

(73) Assignees: thyssenkrupp Uhde GmbH, Dortmund (DE); thyssenkrupp AG, Essen (DE)

(21) Appl. No.: 18/860,576

(22) PCT Filed: Apr. 26, 2023
(86) PCT No.: PCT/EP2023/060929

§ 371 Date: Oct. 25, 2024

(30) Foreign Application Priority Data
Apr. 27, 2022 (BE) BE 2022/5307
Apr. 27, 2022 (DE) 10 2022 204 103.8

(51) Int. Cl. C01C 1/04

(52) U.S. Cl. CPC C01C 1/0482; C01C 1/0417

(57) ABSTRACT

The present disclosure relates to a process for operating an ammonia synthesis plant, wherein the ammonia synthesis plant has a recirculation circuit, wherein the recirculation circuit comprises a converter, a first heat exchanger, a second heat exchanger, an ammonia separator, a compressor and a reactant feed, characterized in that the recirculation circuit comprises a heating element, wherein in case of partial plant utilization the heating power of the heating element is subjected to closed-loop control according to the reactant gas amount supplied via the reactant feed.

The invention relates to a method and to a plant for the synthesis of ammonia with varying load.

Ammonia has been produced for decades predominantly by the Haber-Bosch process. For this purpose, in most cases, hydrogen is first produced from natural gas, and this is reacted with nitrogen under high pressure and at high temperature over a catalyst. Since this is an equilibrium reaction, the equilibrium of which is not shifted to the side of the products, the ammonia is separated off in a recirculation circuit, and unconverted hydrogen and nitrogen are fed back to the catalyst. However, the use of natural gas produces a corresponding amount of carbon dioxide.

In order to sustainably produce ammonia, therefore, there is nowadays a reliance on the electrolysis of water using energy generated from renewable sources (renewably generated energy). However, a major difference from the existing process arises here. If, for example, solar power is used, the diurnal cycle results in a period in which no energy generated from renewable sources is available. For example, the combination of wind and solar power can alleviate this effect to some degree, but the fundamental problem remains. Although it is possible in some regions theoretically to source electrical energy from the public power grid, this too will be suppliable using energy generated from renewable sources only with difficulty in these periods. In addition, there are also planned plants that are set up at locations favorable for energy generation and have no access to an electrical supply grid. The electrolysis of water for production of hydrogen for an ammonia synthesis plant is known, for example, from U.S. Pat. No. 9,463,983 B2.

A converter for the synthesis of ammonia synthesis cannot be simply switched off and on. For example, a temperature of at least 350° C. is needed for the reaction to be able to take place over the catalyst. In the course of operation, the necessary energy (for the compensation of thermal losses) is generated by the energy released in the reaction.

In order to compensate for these fluctuations, corresponding plants especially have energy storage means (batteries) and/or hydrogen storage means. However, even these are sensibly limited to a particular size, or to an economically viable size.

It is an object of the invention to adjust the operation of the ammonia synthesis plant such that these general fluctuations in the provision of reactants for the ammonia synthesis can be compensated for—in particular, fluctuations in the provision of hydrogen. For example, the operation of an ammonia synthesis plant is to be adjusted such that it is nevertheless capable of compensating for the fluctuations in the generation of energy generated from renewable sources with storage means of minimum size.

This object is achieved by the method having the features specified in claim 1 and the ammonia synthesis plant having the features specified in claim 13. Advantageous developments will be apparent from the dependent claims, the description that follows and the drawings.

The method of the invention serves for the operation of an ammonia synthesis plant. The ammonia synthesis plant has a recirculation circuit, as is customary. The recirculation circuit, as known from the prior art, has a converter, a first heat exchanger, a second heat exchanger, an ammonia separator, a compressor, and a reactant feed. The hydrogen-nitrogen mixture is fed in via the reactant feed, conducted through the second heat exchanger and heated, fed to the converter and converted in the converter. The mixture exiting from the converter is guided through the first heat exchanger, where it releases the heat formed by the reaction to a heat carrier medium. (In particular, the first heat exchanger may serve to release the heat energy in the gas mixture from the converter to a heat carrier medium for the utilization of the heat energy outside the recirculation circuit, for which it is disposed downstream of the converter and upstream of the second heat exchanger in the recirculation circuit; in particular, the first heat exchanger may, for instance, be a waste heat boiler, such that the heated heat carrier medium is then hot water, steam, wet steam, saturated steam, heating steam or the like.)

Then the gas mixture is conducted through the second heat exchanger and cooled down (while in return heating the stream flowing toward the converter). (In particular, the second heat exchanger may serve for the release of the heat energy in the gas mixture from the converter for the preheating of the gas mixture prior to introduction into the converter, for which—considered at full load—it is disposed in the recirculation circuit downstream of the first heat exchanger and upstream of the ammonia separator (heat energy-releasing side) and downstream of the ammonia separator and upstream of the converter (heat-absorbing side)). Downstream of the second heat exchanger, the mixture arrives in the ammonia separator, where ammonia is separated off. From the ammonia separator, the unconverted hydrogen-nitrogen mixture is fed back to the converter via the second heat exchanger. The ammonia separator may be of complex construction and may, for example, have a cooling zone and/or further heat exchangers.

According to the invention, the recirculation circuit has a heating element. The heating output of the heating element is under closed-loop control depending on amount of the reactant gas supplied via the reactant feed. While, in normal operation, i.e., typically at 80% to 100% of maximum load, a sufficient amount of thermal energy is generated by the process that it has to be removed via the first heat exchanger, this is no longer the case particularly at low partial loads. Instead, the energy generated by the chemical reaction is in some cases no longer sufficient to compensate for the thermal losses. As a result, there is the risk that the converter will cool down. If the converter cools below a critical temperature, for example 350° C., the chemical reaction can stop completely (in that it slows too much kinetically). But this would mean that further cooling then has to be effected, as a result of which the plant first has to be gradually heated up again and run up. In order to avoid this, according to the invention, the gases present in the recirculation circuit are heated, as a result of which the converter is kept at temperature at all times and hence ready for use, irrespective of load.

Although corresponding heating elements are known for the startup of such plants (as mentioned, for example, by P. Schmitz et al. in “Mechanical integrity of process installations: Barrier alarm management based on bowties” on pages 139-147 in volume 138 of Process Safety and Environmental Protection), what is new is to have these permanently in the recirculation circuit and hence to compensate for the thermal losses of the plant at low partial loads. This process makes it possible to operate the plant even at low partial loads without running down the plant. For example, it is possible thereby to respond better to the diurnal cycle in the case of a purely solar-operated plant, since very low partial loads can then be run in the night without any need for extremely large energy storage means and hydrogen storage means.

Full load (maximum load) is the operation of the plant at the maximum supply of reactant gas mixture and hence the production of the maximum possible amount of ammonia (maximum possible capacity).

Partial load, by comparison with full load, is correspondingly the operation of the plant with supply of reactant gas mixture below the maximum supply of reactant gas mixture at a percentage at which the maximum possible capacity of the plant is exploited. At 50% partial load, for example, only half of the ammonia is produced compared to full load.

In standby operation, there is no synthesis, but the converter and adjoining components are kept at temperature in order to put the plant back into operation rapidly. Standby thus corresponds to a partial load of 0%. In standby operation, accordingly, the plant components upstream of the recirculation circuit are preferably switched off. This relates firstly to the production of the hydrogen and, if appropriate, of the nitrogen. But one of the essential points for standby operation at a partial load of 0% is also the shutdown of the compressors that bring the reactant gases to the pressure of the recirculation circuit (at the same time, a compressor that maintains the flow of the circulation gas within the recirculation circuit should be kept in operation). Even in the case of small partial loads, energy expenditure for this compression is only slightly lower than in full load operation. Therefore, it is possible to save a very large amount of energy in completely shutting down the plant components upstream of the recirculation circuit and keeping only the converter at temperature via the circulation operation.

In the case of complete shutdown, the plant is run down completely; even the converter cools down here. This is necessary, for example, for maintenance or repair measures. In a further embodiment of the invention, the recirculation circuit has a first-heat-exchanger bypass connection (first-heat-exchanger bypass conduit). The first-heat-exchanger bypass connection is arranged for bypassing (bridging across) the first heat exchanger. The first-heat-exchanger bypass connection is switched to bypass the first heat exchanger (for example by opening of a valve in a conduit that connects the inlet of the first heat exchanger to the outlet of the first heat exchanger, bypassing the first heat exchanger) if the amount of reactant gas fed in via the reactant feed goes below a proportion of 25% of the maximum amount, preferably of 20% of the maximum amount, or, in other words, when the partial load has been lowered to 25% of the maximum load of the plant, preferably to 20% of the maximum load of the plant. In order to minimize the energy to be introduced via the heating element, it is therefore advantageous to rule out heat loss via the first heat exchanger. In addition, this decreases the flow resistance and hence reduces the pressure drop to be bridged by the compressor, which saves further energy.

In a further alternative embodiment of the invention, the ammonia synthesis plant has a heat carrier medium bypass connection (heat carrier medium bypass conduit). The heat carrier medium bypass connection is arranged for bypassing the first heat exchanger in that the heat carrier medium is conducted around the first heat exchanger. The heat carrier medium bypass connection is switched to bypass the first heat exchanger if the amount of reactant gas fed in by the reactant feed goes below a proportion of 25% of 20 the maximum amount, preferably of 20% of the maximum amount, or, in other words, if the partial load has been lowered to 25% of the maximum load of the plant, preferably to 20% of the maximum load of the plant. In order to minimize the energy to be introduced via the heating element, it is therefore advantageous to rule out heat loss via the first heat exchanger. Unlike in the case of the embodiment described above, the first heat exchanger is thus not bypassed; instead, the heat carrier medium is fed into the first heat exchanger such that there is no heat exchange therein.

In a further embodiment of the invention, the heating output Q of the heating element is additionally under closed-loop control depending on the amount of cycle gas flowing through the recirculation circuit. In short: the faster the gas mixture is transported through the converter, the more heat can also be discharged from the converter. It is therefore preferable that the heating output of the heating element is higher when the amount of cycle gas flowing through the recirculation circuit is greater. For example and with preference, the heating output is therefore under closed-loop control proportionally (in a linear correlation) to the amount of cycle gas flowing through the recirculation circuit as a percentage V of the maximum amount.

Q∝V

The amount of cycle gas in the context of the invention means a flow rate of the amount of material (molar flow rate) and not a volume flow rate or mass flow rate.

In a further embodiment of the invention, the heating output Q is chosen proportionally with the exponential function of the negative percentage T of the amount of reactant gas fed in via the reactant feed relative to the maximum amount. For this purpose, in particular, the following correlation was thus found empirically:

$$Q ∝ {e}^{- \frac{T}{c o n s {t}_{2}}} ,$$

where const₂ is a constant to be determined for the respective plant (see below).

In a further embodiment of the invention, for a constant partial load, the heating output Q is chosen proportionally to the maximum plant capacity K. For this purpose, in particular, the following correlation was thus found empirically:

Q∝K

In a further embodiment of the invention, the heating output is set to 0 if the amount of reactant gas fed in via the reactant feed exceeds a proportion of 20% of the maximum amount. In the case of a partial load of more than 20%, the energy generated by the chemical reaction is sufficiently high that there is no need for supply via the heating element. Therefore, by way of simplification of the process regime for higher partial loads, the value is set to zero; only below a partial load of 20% is an inventive heating output via the heating element introduced.

For a maximum plant capacity K, it is thus possible with the aid of the aforementioned relations to determine an upper limit and a lower limit for the heating output depending on the recirculation maximum amount V and the amount of reactant gas T supplied, in particular as follows:

In a further embodiment of the invention, accordingly, the upper limit for the heating output Q of the heating element is generally chosen as

$$Q \leq c o n s {t}_{1} \cdot \frac{K \cdot V}{\frac{T}{{e}^{{const}_{2}}}}$$

with K as the maximum plant capacity, V as the amount of cycle gas flowing through the recirculation circuit (reported as a percentage of the maximum recirculation amount) and T as amount of reactant gas fed in (reported as a percentage of the maximum amount). The proportionality constants const₁ and const₂ can be determined for the respective plant. For example, the constants can thus be determined by determining the heating output respectively actually required as a function of the amount of reactant gas supplied (determined as a percentage of the maximum amount) for more than one plant size (accordingly, at least two different capacities of the plant), and then ascertaining the proportionality constants const₁ and const₂ therefrom on the basis of the above formula by curve fitting.

More preferably, the upper limit for the heating output Q of the heating element is chosen as

$$Q \leq 7 \cdot {10}^{- 5} MW / tpd \cdot \frac{K \cdot V}{{e}^{\frac{T}{2.5}}} .$$

In this case, an upper limit of 7·10⁻⁵ MW/tpd is used as const₁, and 2.5 as const₂; the capacity K is used in tonnes per day (tpd), based on the mass of ammonia produced in the plant, and T and V are used as a percentage, so as to then give the heating output in MW. Such a value has been found to be a good approximation for an upper limit in a multitude of different plants.

In this case, the heating output Q actually required will thus be less than the value reported, for example when the outside temperature is comparatively high or other influences reduce an outflow of heat.

In a further embodiment of the invention, the lower limit for the heating output Q of the heating element is chosen as

$$Q \geq c o n s {t}_{3} \cdot \frac{K \cdot V}{{e}^{\frac{T}{c o n s {t}_{2}}}} .$$

The proportionality constants const₃ and const₂ can especially be determined for the respective plant in an analogous manner to the proportionality constants const₁ and const₂.

The lower limit for the heating output Q of the heating element is more preferably chosen as

$$Q \geq 0 \text{.07} \cdot {10}^{- 5} MW / tpd \cdot \frac{K \cdot V}{{e}^{\frac{T}{2.5}}} .$$

In this case, a lower limit of 0.07·10⁻⁵ MW/tpd is used as const₁, and 2.5 as const₂, and the capacity K is used in tonnes per day (tpd), based on the mass of ammonia produced in the plant, and K and V are used as a percentage, so as to then give the heating output in MW. Such a value has been found to be a good approximation for a lower limit in a multitude of different plants.

In a further embodiment of the invention, the lower limit for the heating output Q of the heating element is chosen as

$$Q \geq 0.1 kW / tpd \cdot K$$

with 0% amount of reactant gas supplied (for instance in standby operation). This is the customary lower limit even under optimal conditions.

More preferably, the amount of heat Q between this upper limit and this lower limit at a partial load between 20% and 0% is chosen such that the temperature in the converter does not go below a target temperature, for example 370° C.

In a further embodiment of the invention, the recirculation circuit has an ammonia separator bypass connection (ammonia separator bypass conduit). The ammonia separator bypass connection is arranged for bypassing the ammonia separator. The ammonia separator bypass connection is switched to completely bypass the ammonia separator, for example, if the amount of reactant gas fed in via the reactant feed goes below a proportion of 10% of the maximum amount, preferably of 5% of the maximum amount, more preferably when this is lowered to 0%, i.e. there is no longer any conversion. Bypassing the ammonia separator with simultaneous further supply of reactant gas mixture is therefore especially advisable in particular during conversion to standby operation (0% partial load) and when running up again.

In a further embodiment of the invention, the recirculation circuit has an ammonia separator bypass connection. The ammonia separator bypass connection is arranged for bypassing the ammonia separator. The ammonia separator bypass connection is switched to partly bypass the ammonia separator if the amount of reactant gas fed in via the reactant feed goes below a proportion of 80% of the maximum amount, preferably of 50% of the maximum amount. In this way, in the case of partial load operation, little or no ammonia is removed from the recirculation circuit, such that, as a result of the equilibrium in the converter, less or no new ammonia is generated and, consequently, less or no reactant gas has to be fed in.

As already set out, it is possible by the invention to compensate for general fluctuations in the provision of reactants of the ammonia synthesis, in particular, for instance, fluctuations in the provision of nitrogen and of hydrogen. Fundamentally, it is immaterial here where the reactants come from and what chemical or physical processes (for instance in production or processing) are used to provide these. For example, those reactants may thus be provided using energy generated conventionally (for instance electrical energy, obtained from nuclear energy or from fossil fuels) or else using energy generated from renewable sources (for instance electrical energy obtained from wind energy, solar energy, bioenergy, or a hydroelectric or geothermal source). In addition, it is also possible to obtain the reactants directly from corresponding processes, in the case of hydrogen for instance from biological processes, from the pyrolysis of hydrocarbons (for instance methane pyrolysis) or from thermal water splitting in a solar furnace. In a further embodiment of the invention, the hydrogen fed to the reactant feed is produced by electrolysis using energy generated from renewable sources. This avoids CO₂ emission by generation of hydrogen from natural gas for example (“green ammonia”). The disadvantage of fluctuating hydrogen production can be compensated for particularly efficiently by the method of the invention.

In a further embodiment of the invention, the decision is made as to the amount of reactant gas supplied as a percentage of the maximum amount depending on prediction (forecast) of energy generation and the available storage capacity for electrical energy and/or hydrogen. Accordingly, in this further embodiment of the invention, the amount of reactant gas which is fed to the converter is thus determined/fixed, especially as a percentage of the maximum amount, on the basis of a prediction of energy generation and the available storage capacity for electrical energy and/or hydrogen. For the operation of the compressor and the keeping of the converter at temperature, a minimum amount of energy is required. Considering, for example, the (hypothetical) case of energy generation by means of solar technology and a comparatively small energy storage means, it may be advisable to stop the synthesis of hydrogen as early as the afternoon and to store the energy in order to have sufficient energy to standby operation (0% partial load) for the period before sunrise. In the case of a very large solar field and a very large battery, it would also be possible to continue operation at night either under full load or only under slightly reduced partial load of 50%, for example. Considering, for example, a further hypothetical case of energy generation by wind power in the offshore sector, it is possible, for example, in the event of a forecast lack of wind for 3 days, for example, to put operation on standby in correspondingly good time (0% partial load), such that the energy from the energy storage means is then sufficient to cover standby operation for the period of lack of wind.

In a further embodiment of the invention, the further electrical loads, especially the compressor, are taken into account for the decision. Accordingly, in this further embodiment of the invention, the amount of reactant gas which is fed to the converter is thus determined/fixed, especially as a percentage of maximum amount, taking account of the further electrical loads, especially the compressors. This particularly concerns the energy required by these in the period of time to be covered.

In a further embodiment of the invention, the plant components of the ammonia synthesis plan that are disposed upstream of the recirculation circuit (and hence outside the recirculation circuit) are shut down when the amount of reactant gas supplied is 0%.

In a further embodiment of the invention, a deep standby is defined as a further state of operation. For deep standby, the temperature in the converter is lowered, for example, to from 250° C. to 300° C. By contrast with (regular) standby, this means that no direct startup is possible. First of all, the converter has to be heated up again, for example at 50 K/h. This takes 2 h, for example, in order to bring the converter back to temperature, such that the reaction over the catalyst can be effected again. For this purpose, radiative emission of energy is greatly reduced, such that the energy requirement is greatly lowered compared to standby operation and hence it is possible to cover a longer period with reduced energy production.

In a further aspect, the invention relates to an ammonia synthesis plant for execution of the method of the invention. The ammonia synthesis plant, like ammonia synthesis plants according to the prior art, has a recirculation circuit. The recirculation circuit has a converter, a first heat exchanger, a second heat exchanger, an ammonia separator, a compressor, and a reactant feed. The hydrogen-nitrogen mixture is fed in by the reactant feed, conducted through the second heat exchanger and heated, fed to the converter and converted in the converter. The mixture exiting from the converter is conducted through the first heat exchanger, where it releases the heat formed by the reaction to a heat carrier medium. In particular, the first heat exchanger may, for instance, be a waste heat boiler (such that the heated heat carrier medium is then hot water, steam, wet steam, saturated steam, heating steam or the like). Then the gas mixture is conducted through the second heat exchanger and cooled down (while in return heating the stream flowing toward the converter). Downstream of the second heat exchanger, the mixture arrives in the ammonia separator, where further cooling is effected and ammonia is separated off. From the ammonia separator, the unconverted hydrogen-nitrogen mixture is fed back to the converter via the second heat exchanger.

According to the invention, the recirculation circuit has a heating element. The ammonia synthesis plant also has a control device. The ammonia synthesis plant has a reactant stream feed detection device and a cycle gas amount detection device. The control device is connected to the reactant stream feed detection device for the transmission of the reactant flow rate (the volume flow rate of the reactant supplied) and to the cycle gas amount detection device for the transmission of the amount of cycle gas. The control device is connected to the heating element for the closed-loop control of the heating element. As a result, the control device knows the percentage partial load with the aid of the reactant stream feed detection device, and can thus make a corresponding adjustment of the heating output of the heating element in accordance with the method of the invention.

“Reactant stream feed detection device” should be understood broadly in the context of the invention. Firstly, it is of course possible to detect the gas stream directly, for example via the flow rate and pressure. But the detection can also be effected indirectly, for example via the power consumption of a hydrogen electrolysis and the resultant hydrogen stream that flows to the recirculation circuit from the electrolysis apparatus.

In a further embodiment of the invention, the recirculation circuit has a first-heat-exchanger bypass connection, where the first-heat-exchanger bypass connection is arranged for bypassing the first heat exchanger. As a result, in the case of falling partial load, the first heat exchanger can be bypassed first with the abovementioned advantages.

In a further embodiment of the invention, the recirculation circuit has an ammonia separator bypass connection, where the ammonia separator bypass connection is arranged for bypassing the ammonia separator. The ammonia separator bypass connection, as set out above, is used at low partial loads, especially in the case of standby operation (0% partial load).

In a further embodiment of the invention, the heating element is disposed between the second heat exchanger and the converter.

In a further alternative embodiment of the invention, the heating element is disposed in the second heat exchanger.

In a further alternative embodiment of the invention, the heating element is disposed in the converter.

In a further embodiment of the invention, the heating element is an electrical heating element.

In a further alternative embodiment of the invention, the heating element is an ammonia burner. It is true that an ammonia burner makes little economic sense since the energy which is generated in the combustion of ammonia is lower than that required for synthesis. But this may nevertheless be viable, especially when a connection to a public power grid is impossible, for example in the case of an offshore application. Secondly, it is naturally possible thereby to bridge slightly longer periods of time, for example a lack of wind, in a simple manner without requiring extremely large batteries. This too may therefore be a crucial parameter, for example, in the offshore sector, where space is also a major aspect.

In a further embodiment of the invention, the recirculation circuit has a second-heat-exchanger bypass connection (second-heat-exchanger bypass conduit), where the second-heat-exchanger bypass connection is arranged for bypassing the second heat exchanger between the ammonia separator bypass connection and the converter.

The method is to be illustrated by way of example hereinafter. The decision (determination/stipulation) of how the ammonia synthesis plant is operated includes in particular, firstly, the charge state of an energy storage means (batteries) and/or the charge state of a hydrogen storage means. The capacity of the battery is EB. The capacity of a hydrogen storage means may be reported as a molar amount (mol, kg); for the simplification of the calculation, this amount may alternatively be converted to the equivalent energy that would be needed for generation or would be expended for the production thereof, i.e. as the energy equivalent EH. In addition, the power requirement for standby (PS, minimum energy consumption with shutdown of all components outside the recirculation circuit, especially an optional hydrogen electrolysis) is taken into account, i.e., the minimum energy consumption of the plant. Additionally defined is the power demand PO for operation at the lowest possible throughput plus the power demand PE for the hydrogen electrolysis at the lowest possible throughput. In addition, there is the forecast of the expected energy generated from renewable sources. This is considered in two time intervals. The first forecast relates to a first time window T1 of, for example and in particular, 4 h. The first time window may especially be adjusted depending on the local and/or temporal forecast accuracy. This will be considered to be comparatively reliable. In addition, a second time window T2 of about 4 to 72 h is considered, where the prediction accuracy here is correspondingly lower. A first amount of energy E1 is to be expected/predicted for the first time interval T1, and a second amount of energy E2 for the second time interval T2. In order to estimate the uncertainty in the prediction in energy production, it is possible to introduce a certainty factor S which is preferably between 0.7 (cautious) and 1 (confident). In addition, it is advisable to define a minimum charge state of the battery EBC at which the battery is normally charged. In this way, it is possible, for example, to prevent deep discharge. If a time interval T is considered, the energy requirement is found from the multiplication of the power demand by the time; in other words, the energy requirement EO for operation at the lowest possible throughput is the product of PO and T, and the energy requirement EE for hydrogen electrolysis at the lowest possible throughput is the product of PE and T.

A few special cases are considered hereinafter.

A first scenario considered is that the battery and the hydrogen storage means are either empty or absent. A distinction is made between two subscenarios for this scenario. In the case of falling energy generation, as soon as energy generation in the forecast window T1 falls below the value of the sum total of PO and PE, the system is put into standby operation. If the value falls further below the value ES, complete shutdown is necessary. If energy generation rises while the plant is in standby, it is put back into normal operation as soon as energy generation is always greater than EO plus EE for the whole period T1.

A second scenario considered is the scenario in which a battery is present (and at least partly charged) but no hydrogen storage means is present or it is empty. Here too, a distinction is made between the two subscenarios depending on whether the expected energy production is rising or falling. In the case of falling energy production, the system is switched to standby operation as soon as the sum of E1 and EB is less than the product of time T1 and the sum of PO and PE. Fluctuations within the time interval can then no longer be absorbed from the battery.

$$E 1 + EB < ( PO + PE ) * T 1$$

If the period T2 is also to be considered, it is advantageous to take account of the certainty factor S. This is applied to the expected energy production.

$$E 2 ⋆ S + EB < ( PO + PE ) * T 2$$

If undersupply is expected here, the system is also switched to standby operation.

In the case that energy generation rises again, the situation is correspondingly reversed; the system is switched back to normal operation as soon as the sum of E1 and EB is greater than the product of time T1 and the sum of PO and PE.

$$E 1 + EB > ( PO + PE ) * T 1$$

The consideration for the second time window T2 may be analogous:

$$E 2 ⋆ S + EB > ( PO + PE ) * T 2$$

Here too, the certainty factor is preferably taken into account.

In a third scenario, both a battery and a hydrogen storage means are present and are also each at least partly charged or filled. And here too, a distinction is made between the two subscenarios that energy production is falling or rising. In this case, in the event of falling energy production, the system is switched to standby operation as soon as the sum of E1, EB and EH is less than the product of time T1 and the sum of PO and PE. Fluctuations within the time interval can then no longer be absorbed from the battery.

$$E 1 + EB + EH < ( PO + PE ) * T 1$$

If the period T2 is also to be considered, it is advantageous to take account of the certainty factor S. This is applied to the expected energy production.

$$E 2 ⋆ S + EB + EH < ( PO + PE ) * T 2$$

If undersupply is expected here, the system is also switched to standby operation. When energy generation is rising again, the situation is correspondingly reversed; the system is switched back to normal operation as soon as the sum of E1, EB and EH is higher than the product of the sum of PO and PE multiplied by time T1.

$$E 1 + EB + EH > ( PO + PE ) * T 1$$

The consideration can be analogous for the second time window T2:

$$E 2 ⋆ S + EB + EH > ( PO + PE ) * T 2$$

Here too, the certainty factor is preferably taken into account.

If the minimum charge state of the battery EBC is to be taken into account, it is possible to replace each EB above with (EB-EBC).

There follows a detailed elucidation of the ammonia synthesis plant of the invention with reference to a working example shown in the drawings.

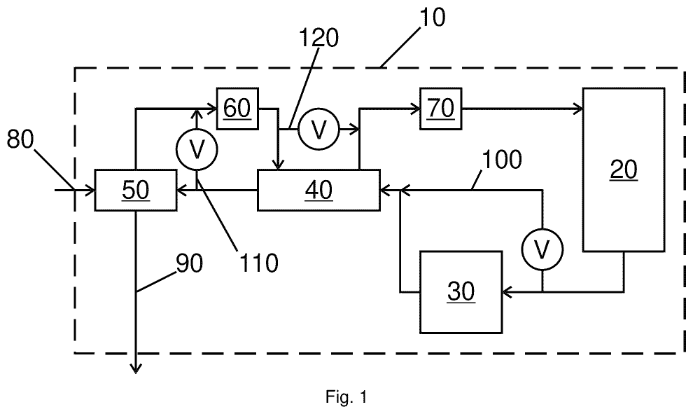

FIG. 1 Schematic diagram of a recirculation circuit

FIG. 1 shows the recirculation circuit 10 in schematic simplified form. A hydrogen-nitrogen mixture is fed to the recirculation circuit for conversion via the reactant feed 80, where this stream is subject to a significant fluctuation and can fluctuate between 100% (maximum load) and 0% (standby). The gas stream is fed to the converter 20 via the compressor 60 and the second heat exchanger 40. The gas mixture leaving the converter 20, in regular operation, is conducted via the first heat exchanger 30 for the removal of the heat of reaction and the second heat exchanger 40 into the ammonia separator 50. The ammonia is separated off there and removed from the circuit via the product outlet 90.

If the partial load falls below 70%, for example, the ammonia separator bypass connection 110 is partly opened in order that less ammonia condenses in the ammonia separator 50 and the cycle gas has a higher ammonium content. This correspondingly reduces the conversion in the converter 20. As the partial load falls further, the ammonia separator bypass connection 110 is opened ever further. Preferably, in standby operation, the gas stream is conducted completely through the ammonia separator bypass connection 110.

If the partial load falls further, for example below 25%, the first-heat-exchanger bypass connection 100 is opened and hence removal of energy via the first heat exchanger 30 is prevented.

If the partial load falls further, for example below 20%, heating output is introduced into the system via the heating element 70. For example, the heating output is in accordance with:

$$Q = 7 \cdot {10}^{- 5} MW / tpd \cdot \frac{K \cdot V}{{e}^{\frac{T}{2.5}}}$$

Purely by way of example, for a partial load of 10%, a maximum plant capacity of 600 tonnes per day (tpd), based on the mass of ammonia produced in the plant, and a value of 50% of the amount of cycle gas flowing through the recirculation circuit as a percentage of the maximum recirculation amount, the value found is:

$$Q = 7 \cdot {10}^{- 5} \cdot \frac{600 \cdot 50}{{e}^{\frac{10}{2.5}}} MW = 2.1 \cdot {e}^{- 4} MW = 3.8 \cdot {10}^{- 2} MW \approx 40 kW$$

Purely by way of example, for a partial load T of 0% (standby operation), a maximum plant capacity K of 600 tonnes per day (tpd) and a value V of 50 of the amount of cycle gas flowing through the recirculation circuit as a percentage of the maximum recirculation amount, an upper value of 2.1 MW is found.

In the case of very small partial loads, for example below 6%, this is reduced to 0%, i.e., no operation is run between 6% and 0%, and the recirculation circuit is put into standby operation. For this purpose, the ammonia separator 50 is bypassed by the ammonia separator bypass connection 110. The minimum heating output introduced via the heating element 70 is given by:

$$Q = 1 kW / tpd \cdot K$$

For example, for an illustrative plant having a maximum plant capacity of 600 tonnes per day (tpd), a minimum value of 600 KW, corresponding to a heating output of 0.6 MW, is thus found in order to keep the plant in standby operation.

Thus, for the abovementioned plant of capacity 600 tpd in standby operation (T=0) the abovementioned upper limit of 2.1 MW and a lower limit of 600 KW are found, where the specific value is then dependent, for example, on ambient weather conditions and the like and is preferably finely controlled via a temperature detection in the converter.

It is likewise possible to at least partly bypass the second heat exchanger 40 with the second-heat-exchanger bypass connection.

It is therefore possible with the invention to adjust the operation of an ammonia synthesis plant such that it is capable of compensating for the fluctuations in the generation of energy generated from renewable sources with very small storage means. Furthermore, it is possible by the invention to adjust the operation of an ammonia synthesis plant such that these fluctuations in the provision of reactants for the ammonia synthesis can generally be compensated for. For example, it is thus possible to counter fluctuations in the provision of hydrogen that can occur when the provision of hydrogen via tank facilities or long distance pipelines is nonuniform or interrupted, or when provision of hydrogen via reformer plants upstream of the ammonia synthesis is nonuniform, for instance owing to repair activities, maintenance activities or disrupted operations in these reformer plants or because of irregular availability of reactants for these reformer plants, for example hydrocarbons such as methane.

### REFERENCE NUMERALS

10 recirculation circuit
20 converter
30 first heat exchanger
40 second heat exchanger
50 ammonia separator
60 compressor
70 heating element
80 reactant feed
90 product outlet
100 first-heat-exchanger bypass connection
110 ammonia separator bypass connection
120 second-heat-exchanger bypass connection
V valve

1-25. (canceled)

26. A method of operating an ammonia synthesis plant, where the ammonia synthesis plant has a recirculation circuit, where the recirculation circuit has a converter, a first heat exchanger, a second heat exchanger, an ammonia separator, a compressor and a reactant feed, wherein the recirculation circuit has a heating element, where, in the event of partial load, the heating output of the heating element is controlled by closed-loop control depending on the amount of reactant gas supplied via the reactant feed, where the hydrogen fed to the reactant feed is produced by electrolysis using energy generated from renewable sources.

27. The method as claimed in claim 26, wherein the recirculation circuit has a first-heat-exchanger bypass connection, where the first-heat-exchanger bypass connection is arranged for bypassing the first heat exchanger, where the first-heat-exchanger bypass connection is switched to bypass the first heat exchanger if the amount of reactant gas fed in via the reactant feed goes below a proportion of 25% of the maximum amount, preferably of 20% of the maximum amount.

28. The method as claimed in claim 26, wherein the ammonia synthesis plant has a heat carrier medium bypass connection, where the heat carrier medium bypass connection is arranged for bypassing the first heat exchanger, where the heat carrier medium is conducted around the first heat exchanger by the heat carrier medium bypass connection, where the heat carrier medium bypass connection is switched to bypass the first heat exchanger if the amount of reactant gas fed in via the reactant feed goes below a proportion of 25% of the maximum amount, preferably of 20% of the maximum amount.

29. The method as claimed in claim 26, wherein the heating output of the heating element is additionally controlled by closed-loop control depending on the amount of cycle gas flowing through the recirculation circuit.

30. The method as claimed in claim 26, wherein the heating output is chosen proportional to the exponential function of the negative percentage of the amount of reactant gas fed in via the reactant feed relative to the maximum amount.

31. The method as claimed in claim 26, wherein the heating output is chosen proportional to the maximum plant capacity.

32. The method as claimed in claim 26, wherein the heating output is set to 0 if the amount of reactant gas fed in via the reactant feed exceeds a proportion of 20% of the maximum amount.

33. The method as claimed in claim 26, wherein the heating output Q of the heating element is chosen as
$$Q \leq {const}_{1} \cdot \frac{K \cdot V}{\frac{T}{{e}^{{const}_{2}}}}$$
with K as plant capacity, V as the amount of cycle gas flowing through the recirculation circuit as a percentage of the maximum recirculation amount, T as amount of reactant gas fed in as a percentage of the maximum amount, where, in particular, const₁ may be chosen as 7·10⁻⁵ MW/tpd and const₂ may be chosen as 2.5.

34. The method as claimed in claim 26, wherein the heating output Q of the heating element is chosen as
$$Q \leq {const}_{3} \cdot \frac{K \cdot V}{\frac{T}{{e}^{{const}_{2}}}}$$
with K as plant capacity, V as the amount of cycle gas flowing through the recirculation circuit as a percentage of the maximum recirculation amount, T as amount of reactant gas fed in as a percentage of the maximum amount, where, in particular, const₃ may be chosen as 0.07·10⁻⁵ MW/tpd and const₂ may be chosen as 2.5.

35. The method as claimed in claim 26, wherein the heating output Q of the heating element is chosen as
$$Q = 0.1 kW / tpd \cdot K$$
with 0% amount of reactant gas supplied.

36. The method as claimed in claim 26, wherein the recirculation circuit has an ammonia separator bypass connection, where the ammonia separator bypass connection is arranged for bypassing the ammonia separator, where the ammonia separator bypass connection is switched to completely bypass the ammonia separator if the amount of reactant gas fed in via the reactant feed goes below a proportion of 10% of the maximum amount, preferably of 5% of the maximum amount.

37. The method as claimed in claim 26, wherein the recirculation circuit has an ammonia separator bypass connection, where the ammonia separator bypass connection is arranged for bypassing the ammonia separator, where the ammonia separator bypass connection is switched to partly bypass the ammonia separator if the amount of reactant gas fed in via the reactant feed goes below a proportion of 80% of the maximum amount, preferably of 50% of the maximum amount.

38. The method as claimed in claim 26, wherein the amount of reactant gas which is fed to the converter is determined as a percentage of the maximum amount on the basis of a prediction of energy generation and the available storage capacity for electrical energy and/or hydrogen.

39. The method as claimed in claim 38, wherein the amount of reactant gas which is fed to the converter is determined as a percentage of the maximum amount with consideration of the further electrical loads, especially the compressors.

40. The method as claimed in claim 26, wherein the plant components of the ammonia synthesis plant that are upstream of the recirculation circuit are shut down in the case of 0% amount of reactant gas supplied.

41. An ammonia synthesis plant for the execution of the method as claimed in claim 26, where the ammonia synthesis plant has a recirculation circuit, where the recirculation circuit has a converter, a first heat exchanger, a second heat exchanger, an ammonia separator, a compressor and a reactant feed, wherein the recirculation circuit has a heating element, where the ammonia synthesis plant has a control device, where the ammonia synthesis plant has a reactant stream feed detection device, where the ammonia synthesis plant has a cycle gas amount detection device, where the control device is connected to the reactant stream feed detection device for the transmission of the reactant flow rate, where the control device is connected to the cycle gas amount detection device for the transmission of the amount of cycle gas, where the control device is connected to the heating element for the closed-loop control thereof.

42. The ammonia synthesis plant as claimed in claim 41, wherein the heating element is disposed between the second heat exchanger and the converter, downstream of the second heat exchanger.

43. The ammonia synthesis plant as claimed in claim 41, wherein the heating element is disposed in the second heat exchanger.

44. The ammonia synthesis plant as claimed in claim 41, wherein the heating element is disposed in the converter.

45. The ammonia synthesis plant as claimed in claim 41, wherein the recirculation circuit has a second-heat-exchanger bypass connection, where the second-heat-exchanger bypass connection is arranged for bypassing the second heat exchanger between the ammonia separator bypass connection and the converter.
